(19) United States
(12) Patent Application Publication
(10) Pub. No.: US 2023/0098170 A1
(43) Pub. Date: Mar. 30, 2023

(54) GLASS ANTENNA

(71) Applicant: Nippon Sheet Glass Company, Limited, Tokyo (JP)

(72) Inventor: Hidetoshi OKA, Tokyo (JP)

(73) Assignee: Nippon Sheet Glass Company, Limited, Tokyo (JP)

(21) Appl. No.: 17/802,204

(22) PCT Filed: Feb. 25, 2021
(86) PCT No.: PCT/JP2021/007052

§ 371 Date: Aug. 25, 2022

(30) Foreign Application Priority Data
Feb. 26, 2020 (JP) 2020-031053

(51) Int. Cl. H01Q 9/16; H01Q 1/32; H01Q 15/00

(52) U.S. Cl. CPC H01Q 9/16; H01Q 1/32; H01Q 15/0093

(57) ABSTRACT

The present invention provides a glass antenna to be provided on a window glass of a vehicle, and the glass antenna includes a hot portion, a ground portion, and an antenna main body connected to the hot portion and the ground portion. The glass antenna is configured to receive radio waves with a frequency band of 600 MHz to 5 GHz.

### TECHNICAL FIELD

The present invention relates to a glass antenna to be provided on a window glass of a vehicle.

### BACKGROUND ART

Antennas for transmitting and receiving radio waves over a wide band have a planar shape in order to resonate at various frequencies. (e.g., Patent Literature 1). Incidentally, the current automotive communication technology is shifting from fourth generation communications (4G) to fifth generation communications (5G). In view of this, automobiles also need to have vehicle glass antennas capable of receiving radio waves in 5G frequency bands.

### CITATION LIST

### Patent Literature

Patent Literature 1: WO 2017/018323

### SUMMARY OF INVENTION

### Technical Problem

However, even when 5G is introduced, communication in 4G frequency bands will also be used in combination therewith. Therefore, vehicles, which move around regardless of the 4G and 5G regions, need to be able to receive radio waves in both the 4G and 5G frequency bands. Thus, such vehicles need to be equipped with antennas that support both 4G and 5G. However, so far, glass antennas capable of receiving radio waves corresponding to both 4G and 5G frequency bands are not available, and there is demand for such glass antennas. The present invention was made to resolve this issue, and aims to provide a glass antenna capable of receiving radio waves in frequency bands supported in both 4G and 5G.

### Solution to Problem

Aspect 1. A glass antenna to be provided on a window glass of a vehicle, the glass antenna including:
a hot portion;
a ground portion; and
an antenna main body connected to the hot portion and the ground portion,
in which the glass antenna is configured to receive radio waves with a frequency band of 600 MHz to 5 GHz.

Aspect 2. The glass antenna according to Aspect 1,
in which the antenna main body includes:
a first portion that has a planar shape, and
a second portion that is electrically connected to the first portion and has a planar shape.

Aspect 3. The glass antenna according to Aspect 2,
in which an outer edge of at least one of the first portion and the second portion has at least one corner portion.

Aspect 4. The glass antenna according to Aspect 2,
in which at least one of the first portion and the second portion is formed by a polygon having linear sides.

Aspect 5. The glass antenna according to any one of Aspects 2 to 4,
in which the ground portion is arranged in the vicinity of a portion of an outer peripheral edge of the first portion that is located farthest from the second portion.

Aspect 6. The glass antenna according to Aspect 5,
in which, when the wavelength of the radio waves is λ and the wavelength shortening coefficient in the window glass is α,
the distance from the hot portion to the second portion is α×λ/20 or more.

Aspect 7. The glass antenna according to Aspect 5 or 6,
in which the first portion is larger than the second portion.

Aspect 8. The glass antenna according to any one of Aspects 5 to 7,
in which the first portion and the second portion are formed line symmetrically with respect to a reference line passing through the ground portion and passing through the first portion and the second portion.

Aspect 9. The glass antenna according to any one of Aspects 2 to 4,
in which one vertex of an outer peripheral edge of the first portion and one vertex of an outer peripheral edge of the second portion are arranged so as to face each other.

Aspect 10. The glass antenna according to Aspect 9,
in which the first portion and the second portion have a shape symmetrical with respect to a midpoint between the one vertex of the first portion and the one vertex of the second portion.

Aspect 11. The glass antenna according to Aspect 9 or 10,
in which the hot portion and the ground portion are arranged outside the first portion and the second portion.

Aspect 12. The glass antenna according to Aspect 11, further including:
a first track portion extending so as to connect the ground portion and the first portion to each other; and
a second track portion extending in parallel to the first track portion so as to connect the hot portion and the second portion to each other.

Aspect 13. The glass antenna according to Aspect 12,
in which a gap between the first track portion and the second track portion is 1 mm or less.

### Advantageous Effects of Invention

A glass antenna according to the present invention is capable of receiving radio waves with frequency bands that are supported in both 4G and 5G.

### BRIEF DESCRIPTION OF DRAWINGS

FIG. 1 is a plan view of a portion of a window glass on which a glass antenna of the present invention is arranged.

FIG. 2 is a plan view showing a first glass antenna.

FIG. 3 is a plan view showing a second glass antenna.

FIG. 4 is a plan view showing another example of the first glass antenna.

FIG. 5 is a plan view showing another example of the first glass antenna.

FIG. 6 is a plan view showing another example of the first glass antenna.

FIG. 7 is a plan view showing another example of the first glass antenna.

FIG. 8 is a plan view showing another example of the first glass antenna.

FIG. 9 is a plan view showing another example of the second glass antenna.

FIG. 10 is a plan view showing another example of the second glass antenna.

FIG. 11A is a plan view showing another example of the orientation of the first glass antenna.

FIG. 11B is a plan view showing another example of the orientation of the first glass antenna.

FIG. 11C is a plan view showing another example of the orientation of the second glass antenna.

FIG. 12 is a plan view of a glass antenna according to a comparative example.

FIG. 13 is a graph showing reception performance according to examples 1 to 4 and the comparative example.

FIG. 14 is a plan view of a glass antenna according to an example 5.

FIG. 15 is a graph showing reception performance according to examples 5 to 7.

FIG. 16 is a graph showing reception performance according to examples 5, 8, and 9.

FIG. 17 is a graph showing reception performance according to examples 5, 10, and 11.

FIG. 18 is a graph showing reception performance according to examples 5, 12, and 13.

FIG. 19 is a graph showing reception performance according to examples 5, 14, and 15.

FIG. 20 is a plan view of a glass antenna according to an example 16.

FIG. 21 is a graph showing reception performance according to the example 16.

### DESCRIPTION OF EMBODIMENTS

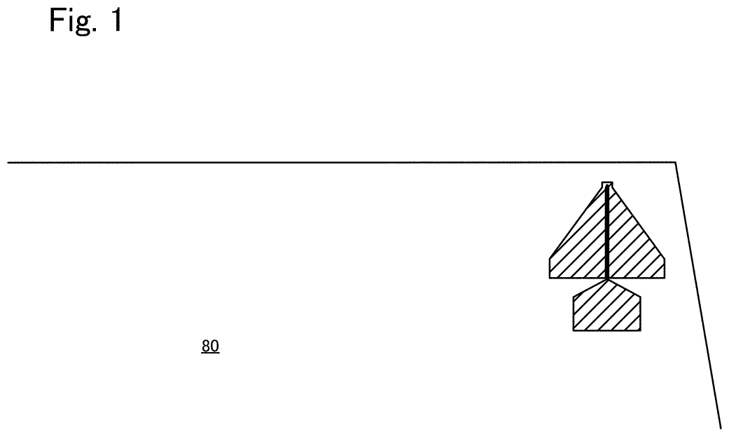

Hereinafter, an embodiment of a glass antenna according to the present invention will be described with reference to the drawings. FIG. 1 is a plan view showing a window glass of a vehicle on which a first glass antenna is arranged. There is no particular limitation to a target window glass as long as it is a window glass for a vehicle, and the glass antenna can be arranged on any one of a windshield, a rear glass, a side glass, and the like. Note that two types of glass antennas, that is, a first glass antenna 10 and a second glass antenna 20, will be described in this embodiment. Note that, although the first glass antenna 10 is shown in FIG. 1, at least one of the glass antennas 10 and 20 is arranged on a window glass. Hereinafter, a window glass 80 will be first described, and then the glass antennas 10 and 20 will then be described in detail.

1. Glass Plate
First, the window glass 80 on which the glass antennas 10 and 20 are arranged will be described. A well-known glass plate for automobiles can be utilized for the window glass 80. Heat absorbing glass, ordinary clear glass, dark privacy glass or dark green glass, or UV green glass may be utilized as the glass plate, for example. Such a glass plate needs, however, to realize a visible light transmittance that meets safety standards of the country in which the automobile is to be used. Solar absorptivity, visible light transmittance, and the like can be adjusted to meet safety standards, for example. Hereinafter, an example of the composition of clear glass and an example of the composition of heat absorbing glass will be shown.

Clear Glass

SiO₂: 70 to 73 mass %
Al₂O₃: 0.6 to 2.4 mass %
CaO: 7 to 12 mass %
MgO: 1.0 to 4.5 mass %
R²O: 13 to 15 mass % (R represents an alkaline metal)
Total iron oxide in terms of Fe₂O₃ (T—Fe₂O₃): 0.08 to 0.14 mass %

Heat Absorbing Glass
The composition of heat absorbing glass can, for example, be given as a composition, based on the composition of clear glass, including total iron oxide in terms of Fe₂O₃ (T—Fe₂O₃) at a ratio of 0.4 to 1.3 mass %, CeO₂ at a ratio of 0 to 2 mass %, and TiO₂ at a ratio of 0 to 0.5 mass %, and in which the skeletal component (mainly SiO₂ or Al₂O₃) of the glass is reduced by an amount equivalent to the increase in T—Fe₂O₃, CeO₂ and TiO₂.

Note that the type of glass plate is not limited to clear glass or heat absorbing glass, and can be selected as appropriate according to the embodiment. The glass plate may be a resin window made of acrylic resin, polycarbonate resin or the like, for example.

Also, the window glass 80 has a curved shape as appropriate. Further, such a window glass 80 maybe a laminated glass in which an interlayer such as a resin film is sandwiched between multiple glass plates, in addition to being a single glass plate. If the window glass is constituted by a single glass plate, a glass antenna is arranged on a surface of the window glass 80 located on the vehicle interior side. On the other hand, if the window glass 80 is a laminated glass, the glass antennas 10 and 20 can be arranged on a surface on the vehicle interior side of the glass plate located on the vehicle interior side, or the glass antennas 10 and 20 can be arranged between two glass plates.

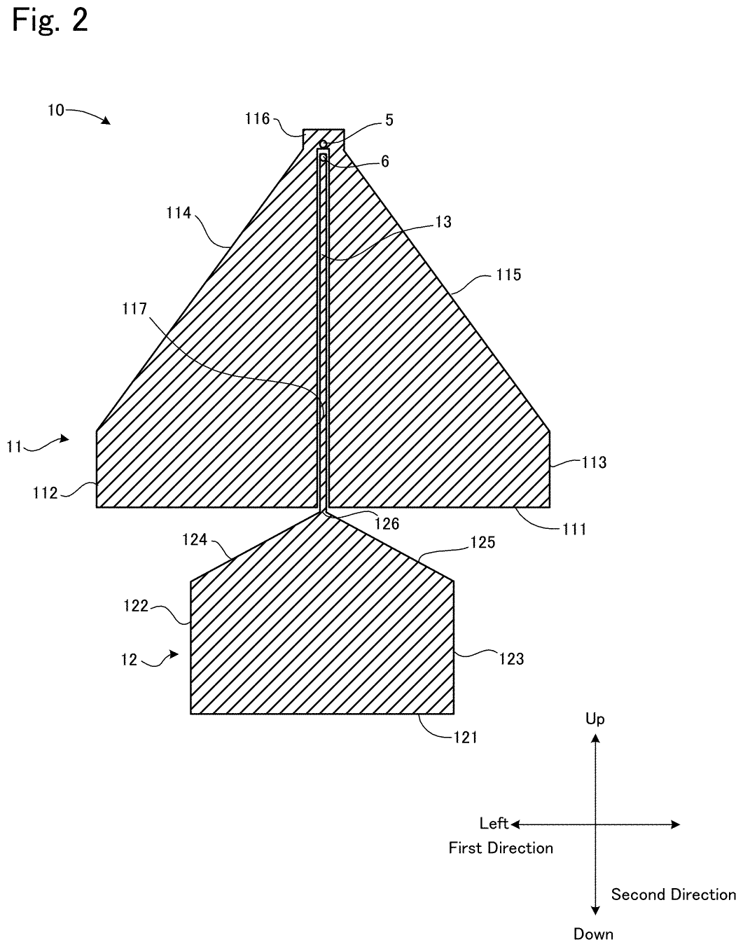

2. First Glass Antenna
Next, the first glass antenna 10 will be described with reference to FIG. 2. FIG. 2 is a plan view showing the first glass antenna. The first glass antenna 10 includes an antenna main body that is arranged on a surface of the window glass 80 on the vehicle interior side and has a first portion 11 and a second portion 12, and also includes a track portion 13. These constituent elements are made in sheet form with a conductive material. Also, the first portion 11 is provided with a ground portion 5, and the track portion 13 is provided with the hot portion 6. The ground portion 5 and the hot portion 6 are connected to a receiver (not shown) provided inside the vehicle by a coaxial cable (not shown). Note that, for convenience of description, the following description will be given according to a first direction shown in FIG. 2 and a second direction that is orthogonal to the first direction. However, although the first direction is a horizontal direction and the second direction is an up-down direction in the example shown in FIG. 2, the present invention is not limited to this. These directions can be changed as appropriate while maintaining the relationship between the first direction and the second direction. The same applies to the second glass antenna 20, which will be described later.

2-1. First Portion
The first portion 11 has a substantially pentagonal shape that is bilaterally symmetrical, and includes a first side 111 that extends in the first direction, a second side 112 and a third side 113 that extend orthogonally upward from two ends of the first side 111, and a fourth side 114 and a fifth side 115 that respectively extend obliquely from upper ends of the second side 112 and the third side 113. The fourth side 114 and the fifth side 115 extend so as to approach each other moving upward, and a rectangular protruding portion 116 is formed at a portion where the upper end portions of the fourth side 114 and the fifth side 115 are joined together.

Also, a slit 117 is provided that extends in the second direction from inside the protruding portion 116, that is, from a position located slightly below the upper edge of the protruding portion 116, to the first side 111. Further, the above-described track portion 13 is disposed in this slit. The track portion 13 has a linear shape and is arranged with a slight space from the inner edge of the slit 117. Also, a lower end of the track portion 13 is connected to the second portion 12. Note that, although there is no particular limitation to the length of the track portion 13, that is, the distance from the hot portion 6 to the second portion 12, in order to improve reception performance, the length of the track portion 13 is preferably α×λ/20 (α represents a wavelength shortening coefficient in the window glass) or more where the wavelength of the radio waves received is λ and a wavelength shortening coefficient α in a typical window glass is in a range of 0.6 to 0.7, for example.

The above-described ground portion 5 is provided in the protruding portion 116, and the hot portion 6 is provided at the upper end of the track portion 13. Therefore, the ground portion 5 and the hot portion 6 are spaced apart from each other with the slit 117 interposed therebetween.

2-2. Second Portion
Next, the second portion 12 will be described. The second portion 12 is arranged below the first portion 11. The second portion 12 has a substantially pentagonal shape (home base shape) that is bilaterally symmetrical, and includes a first side 121 that extends in the first direction, a second side 122 and a third side 123 that extend orthogonally upward from two ends of the first side 121, and a fourth side 124 and a fifth side 125 that respectively extend obliquely from upper ends of the second side 122 and the third side 123. The fourth side 124 and the fifth side 125 extend so as to approach each other moving upward. Further, the upper end portions of the fourth side 124 and the fifth side 125 are in contact with each other, forming an upper vertex 126. The lower end of the track portion 13 is connected to the upper vertex 126.

The second portion 12 is smaller than the first portion 11, and as shown in FIG. 2, for example, the lengths of the second portion 12 in the first direction and the second direction can be each about half of the length of the first portion 11.

As described above, the antenna main body of the first glass antenna 10 is formed bilaterally symmetrically with respect to the reference line (a line extending along the track portion 13) that passes through the ground portion 5 and extends in the up-down direction.

There is no particular limitation to the size of the first glass antenna 10, and the length of the first glass antenna 10 in the first direction preferably ranges from 30 mm to 90 mm, and more preferably ranges from 40 mm to 80 mm, for example. On the other hand, the length of the first glass antenna 10 in the second direction preferably ranges from 20 mm to 80 mm, and more preferably ranges from 30 mm to 70 mm. The same applies to the second glass antenna 20.

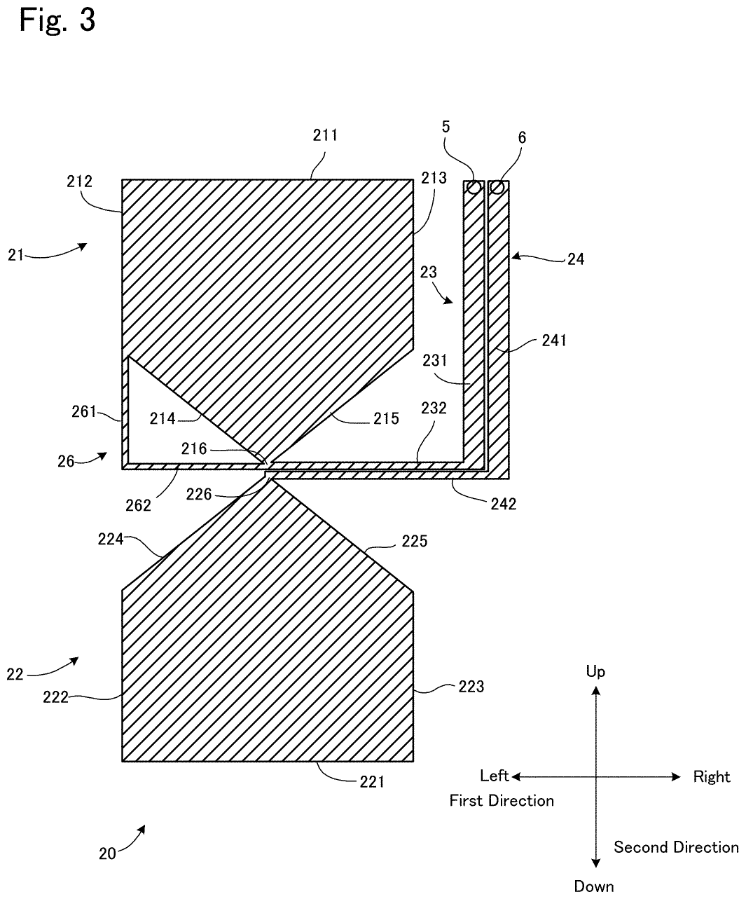

3. Second Glass Antenna
Next, the second glass antenna 20 will be described with reference to FIG. 3. FIG. 3 is a plan view showing the second glass antenna. The second glass antenna 20 includes an antenna main body that is arranged on a surface of the window glass 80 on the vehicle interior side and has a first portion 21 and a second portion 22, and also includes a first track portion 23, a second track portion 24, and an extension portion 26. These constituent elements are made in sheet form with a conductive material. Also, the first track portion 231 is provided with a ground portion 5, and the second track portion 24 is provided with the hot portion 6. Similarly to the first glass antenna, these ground portion 5 and hot portion 6 are connected to a receiver provided inside the vehicle by a coaxial cable.

3-1. First Portion
The first portion 21 has a substantially pentagonal shape that is bilaterally symmetrical, and includes a first side 211 that extends in the first direction, a second side 212 and a third side 213 that extend orthogonally downward from two ends of the first side 211, and a fourth side 214 and a fifth side 215 that respectively extend obliquely from lower ends of the second side 212 and the third side 213. The fourth side 214 and the fifth side 215 extend so as to approach each other moving downward. Further, the lower end portions of the fourth side 214 and the fifth side 215 are in contact with each other, forming a lower vertex 216.

3-2. Second Portion
The second portion 22 is arranged below the first portion 21, and has a shape vertically symmetrical with the first portion 21. That is, the second portion 22 has a substantially pentagonal shape that is bilaterally symmetrical, and includes a first side 221 that extends in the first direction, a second side 222 and a third side 223 that extend orthogonally upward from two ends of the first side 221, and a fourth side 224 and a fifth side 225 that respectively extend obliquely from upper ends of the second side 222 and the third side 223. The fourth side 224 and the fifth side 225 extend so as to approach each other moving upward. Further, the upper end portions of the fourth side 224 and the fifth side 225 are in contact with each other, forming an upper vertex 226. The upper vertex 226 and the lower vertex 216 of the first portion 21 are arranged with a slight gap interposed therebetween, and the first track portion 23 and the second track portion 24 are arranged in this gap.

3-3. First Track Portion and Second Track Portion
The first track portion 23 is arranged on the right side of the first portion 21 and has an L-shape. That is, the first track portion 23 includes a first line portion 231 that extends in the up-down direction and a second line portion 232 that extends from the lower end of the first line portion 231 leftward in the horizontal direction. The position of the upper end of the first line portion 231 in the up-down direction is substantially the same as the position of the first side 211 of the first portion 21. Also, the position of the lower end of the first line portion 231 in the up-down direction is substantially the same as the position of the lower vertex 216 of the first portion 21. Therefore, the left end portion of the second line portion 232 is connected to the lower vertex 216.

The second track portion 24 is also arranged on the right side of the first portion 21 and has an L-shape. That is, the second track portion 24 includes a first line portion 241 that extends in the up-down direction and a second line portion 242 that extends from the lower end of the first line portion 241 leftward in the horizontal direction. The first line portion 241 has substantially the same length as the first line portion 231 of the first track portion 23, and extends in parallel to the first line portion 231 on the right side of the first line portion 231 with a gap interposed therebetween. Similarly, the second line portion 242 has substantially the same length as the second line portion 232 of the first track portion 23, and extends in parallel to the second line portion 232 on the lower side of the second line portion 232 with a gap interposed therebetween. Also, the left end portion of the second line portion 242 is connected to the upper vertex 226 of the second portion 22. There is no particular limitation to the length of the gap interposed between the first track portion 23 and the second track portion 24, and according to the inventors of the present invention, the length of the gap is 1 mm or less, preferably 0.5 mm or less, and more preferably 0.1 mm or less in order to improve reception performance. Note that, similarly to the first glass antenna 10, the length of the track portions 23 and 24 can be α×λ/20.

Also, the upper end of the first line portion 231 of the first track portion 23 is provided with the ground portion 5, and the upper end of the first line portion 241 of the second track portion 24 is provided with the hot portion 6.

3-4. Extension Portion
The extension portion 26 is arranged on the left side of the first portion 21, and has an L-shape. That is, the extension portion 26 includes a first line portion 261 that extends in the up-down direction and a second line portion 262 that extends from the lower end of the first line portion 261 rightward in the horizontal direction. The upper end of the first line portion 261 is connected to an intersection of the second side 212 and the fourth side 214 of the first portion 21. Also, the right end portion of the second line portion 262 is connected to the left end portion of the first track portion 23.

4. Materials
The first glass antenna 10 and the second glass antenna 20 such as described above can be formed by laminating a conductive material having conductivity on the surface of the window glass 80, such that a predetermined pattern is formed. Any conductive material can be adopted as such a material, and examples thereof may include silver, gold, copper, platinum, and ITO (indium tin oxide). Specifically, these antennas can be formed by, for example, printing and baking a conductive silver paste containing silver powder, glass frit and the like on the surface of the window glass 80, for example. In addition, it is also possible to use a conductor that can be formed through direct deposition on the glass surface, such as ITO. If a material can be formed into the form of a foil, an antenna can also be formed by cutting the foil into a predetermined shape. If a colored conductor is to be formed, in order to secure the field of view from the inside of the vehicle, an antenna can also be formed by cutting a sheet structure in which the conductor is formed as thin lines into a mesh pattern, or by printing such a sheet structure directly on the surface of the window glass, for example. Also, there is no particular limitation to the thicknesses of the glass antennas 10 and 20, and the glass antennas 10 and 20 each have a thickness of 0.01 to 50 μm, for example.

5. Characteristics
As described above, because the glass antennas 10 and 20 according to this embodiment includes two planer portions, it is possible to obtain favorable reception performance in frequency bands for both 4G and 5G. Amore detailed description is given below.

It is assumed that the 4G and 5G frequency bands are in a range of 600 MHz to 5 GHz. Because a conventional linear antenna can resonate only in a given range of frequencies corresponding to the segment length of the antenna cable, the receivable band can only be several hundred MHz at its widest. In view of this, by forming an assembly of antenna cables with a certain range of segment lengths, that is, by forming antenna cables in a planar shape, cable segments in which radio waves resonate over a wide band of several GHz occur in several places in the plane. Thus, favorable reception performance can be obtained.

If an outer edge has a corner portion, such as in the first portions 11 and 21 and the second portions 21 and 22 described above, cable segments in which radio waves resonate, such as a cable segment extending diagonally from this corner portion, tend to occur. Also, if the outer edge has a plurality of corner portions, radio waves tend to resonate on a cable segment connecting corner portions. Thus, it is possible to further improve reception performance. Further, because the first portions 11 and 21 and the second portions 21 and 22 have a polygonal shape, radio waves tend to also resonate on the linear sides. Thus, it is possible to further improve reception performance.

When the length of the track portions 13 and 24 from the hot portion 6 is set to α×λ/20 or more, the track portion 23 that has substantially the same length as the track portions 13, 24, and 24 can function as a part of an impedance matching element. Thus, it is possible to further improve reception performance.

Also, when the first portion 21 and the second portion 22 are symmetrical with each other, such as in the second glass antenna 20, segments in which radio waves resonate occur symmetrically. Thus, it is possible to further improve reception performance.

If a planar antenna of the present invention is constituted by a colored conductor, for example, light does not pass through the colored portion, obstructing the field of view. In view of this, as a result of forming an antenna by a structure in which fine lines of the conductor are formed in a mesh pattern, light can partially pass through this portion, and obstruction of the field of view can be reduced. It is more preferable to use a transparent conductor because obstruction of the field of view is eliminated.

6. Variations
Although an embodiment of the present invention has been described above, the present invention is not limited to the above embodiment, and various modifications can be made without departing from the spirit of the present invention. Note that the following variations can be combined as appropriate.

The glass antenna can have various shapes, and the shape of the glass antenna is not limited to the above embodiment.

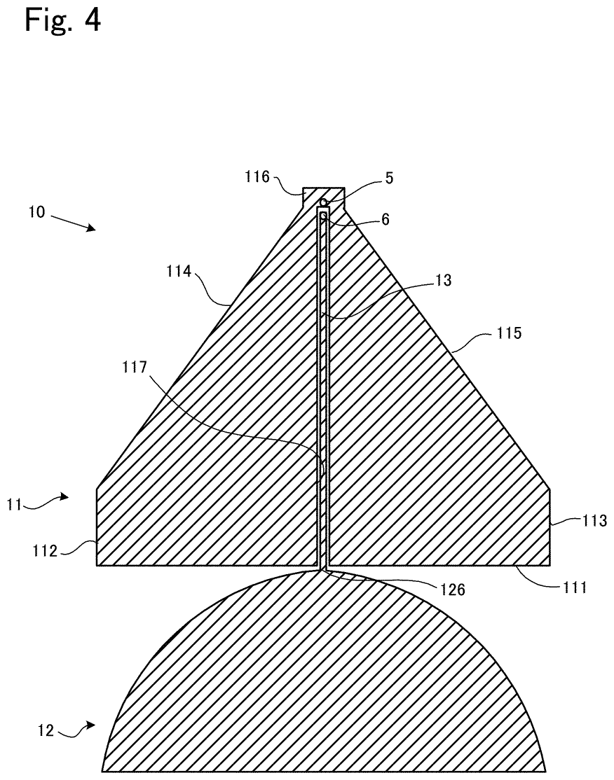

(1) There is no particular limitation to the shapes of the first portions 11 and 21 and the second portions 12 and 22 of the glass antennas 10 and 20. These portions may have a polygonal shape or a circular shape, and may also have an outer edge in which straight lines and curved lines are mixed with each other. In the example shown in FIG. 4, a portion of the outer edge of the second portion 12 in the first glass antenna 10 is constituted by a curved line, for example. However, according to the inventors of the present invention, it is preferable that the outer peripheral edge of each portion is constituted by a straight line and has at least one corner portion in order to improve reception performance.

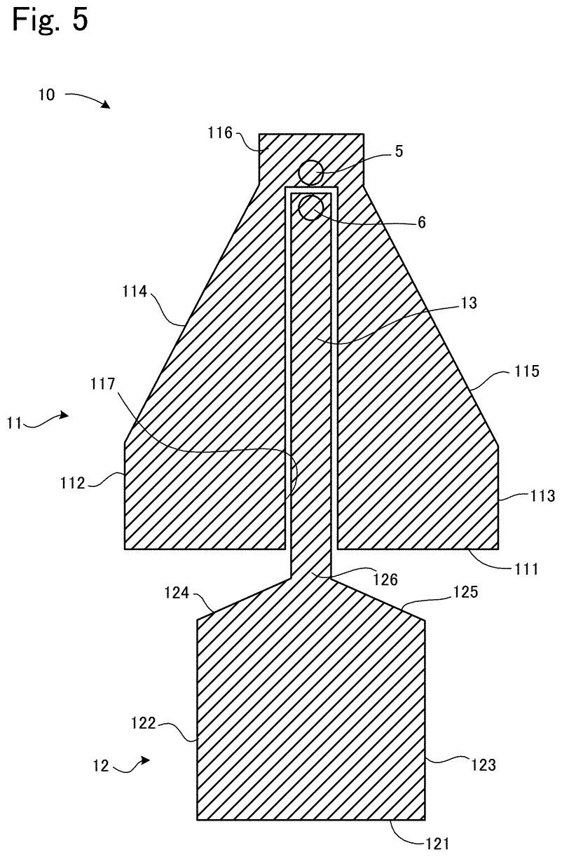

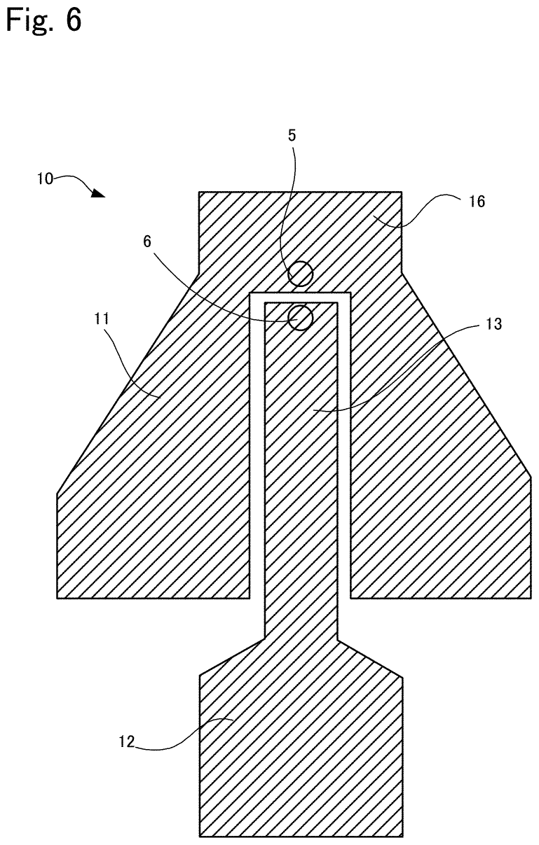

(2) The shape of the first glass antenna 10 in FIG. 2 is an example, and as shown in FIG. 5, the width thereof in the first direction can be reduced, and the width of the slit 117 or the track portion 13 can also be increased, for example. Also, as shown in FIG. 6, the width of the first portion 11 can be set to two times or more the width of the second portion 12, and the width of the protruding portion 16 can be further increased.

Although the two portions of the above-described first glass antenna 10 have different sizes, they may have the same size. However, according to the inventors of the present invention, it is preferable that the first portion is larger than the second portion in order to improve reception performance.

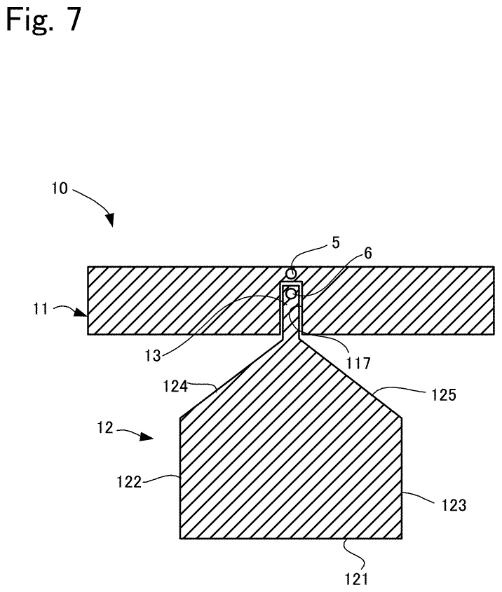

Also, although the shape of the first portion 11 is a substantially pentagonal shape in the above-described first glass antenna 10, the shape of the first portion 11 is not limited to this and may have other shapes. As shown in FIG. 7, the first portion 11 may have a rectangular shape, for example. The first portion 11 in this example is formed in a rectangular shape that is longer in the lateral direction than in the longitudinal direction, and the length of the first portion 11 in the lateral direction is longer than the length of the second portion 12 in the lateral direction.

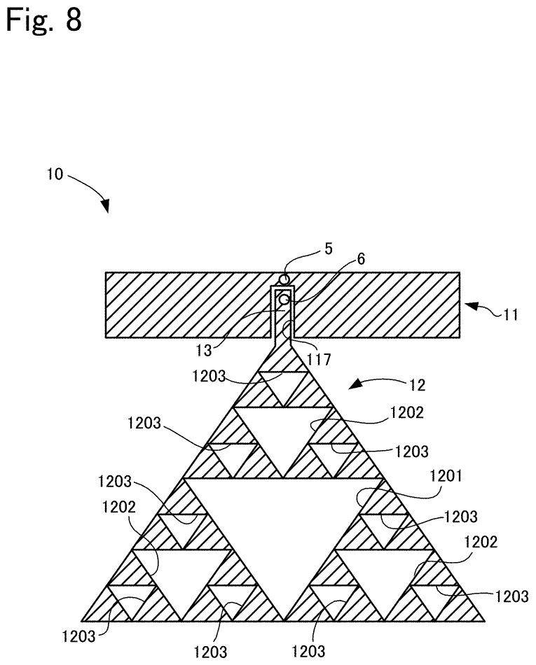

Also, there is no particular limitation to the shape of the second portion 12, and the second portion 12 can have the shape shown in FIG. 8. In this example, the first portion has the shape shown in FIG. 7, and the second portion 12 has a triangular shape. More specifically, in the example shown in FIG. 8, the second portion 12 has a substantially triangular shape, and the track portion 13 is connected to the vertex of the upper portion thereof. Also, the second portion 12 is provided with a plurality of triangular through-holes. Specifically, a first triangle 1201 is formed by connecting the midpoints of the sides of the triangle that constitutes the second portion 12, forming a through-hole. Further, in the second portion 12, second triangles 1202 are each formed by connecting the midpoints of the sides of the respective one of the three triangles that are formed above and to the left and right of the first triangle 1201, forming through-holes. Also, in the second portion 12, third triangles 1203 are each formed by connecting the midpoints of the sides of the respective one of the three triangles that are formed above and to the left and right of the second triangle 1202, forming through-holes. In this manner, the second portion 12 is provided with thirteen through-holes having three types of inverted triangular shapes. Note that, although the through-holes have inverted triangular shapes in this example, there is no particular limitation to the shape of the through-holes. The through-holes may have various shapes such as polygonal shapes, circular shapes, and irregular shapes. There is also no particular limitation to the positions of the through-holes.

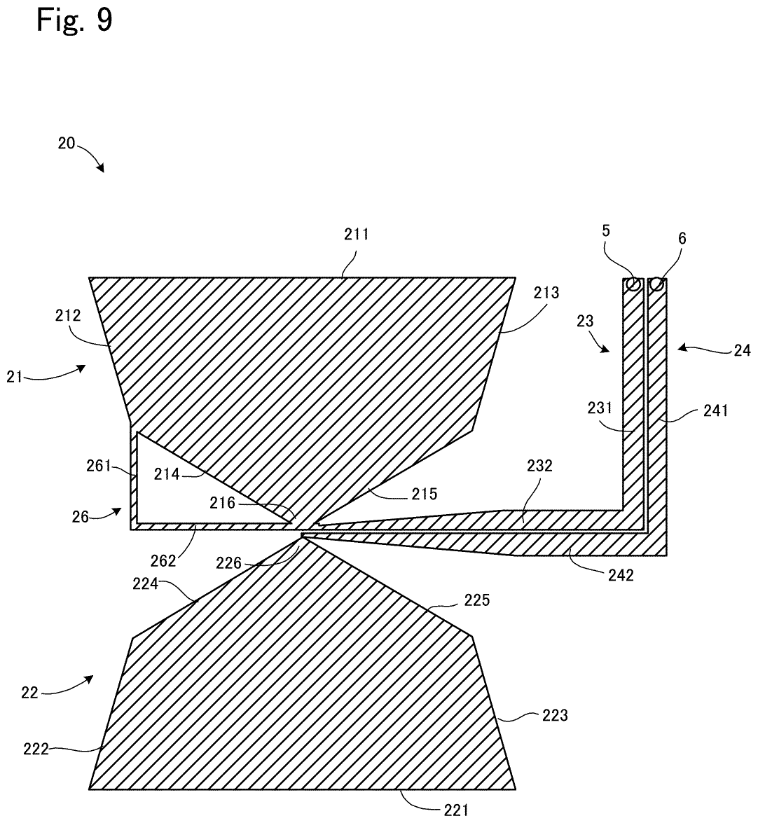

(3) There is also no particular limitation to the shapes of the portions of the second glass antenna, and as shown in FIG. 9, the second sides 212 and 222 and the third sides 213 and 223 in the portions 21 and 22 may incline obliquely, for example. Also, as shown in FIG. 10, an extension portion need not be provided. Further, the track portions 23 and 24 may also be formed in a straight line, and there is no particular limitation to the shapes of the track portions.

Although the two portions of the second glass antenna 20 have the same shape, they may have different shapes. However, according to the inventors of the present invention, in order to improve reception performance, it is preferable that the first portion and the second portion have the same size and are arranged point-symmetrically with each other. Although the vertexes of the portions 21 and 22 are preferably arranged facing each other, there is no limitation to this.

(4) As described above, in the first glass antenna 10, the first portion 11 is provided with the slit 117, and the track portion 13 is arranged in this slit 117. That is, the track portion 13 is arranged inside the first portion 11. On the other hand, in the second glass antenna 20, the track portions 23 and 24 are arranged outside the portions 21 and 22.

However, as will be described in the following examples, it has been found that the shapes and the positions of the track portions do not greatly influence reception performance. Therefore, there is no particular limitation to the positions and the shapes of the track portions. Thus, the track portions 23 and 24 in the second glass antenna 20 need not extend in parallel to each other, and may be separated from each other. Although there is also no particular limitation to the positions of the ground portion 5 and the hot portion 6, they are preferably close to each other.

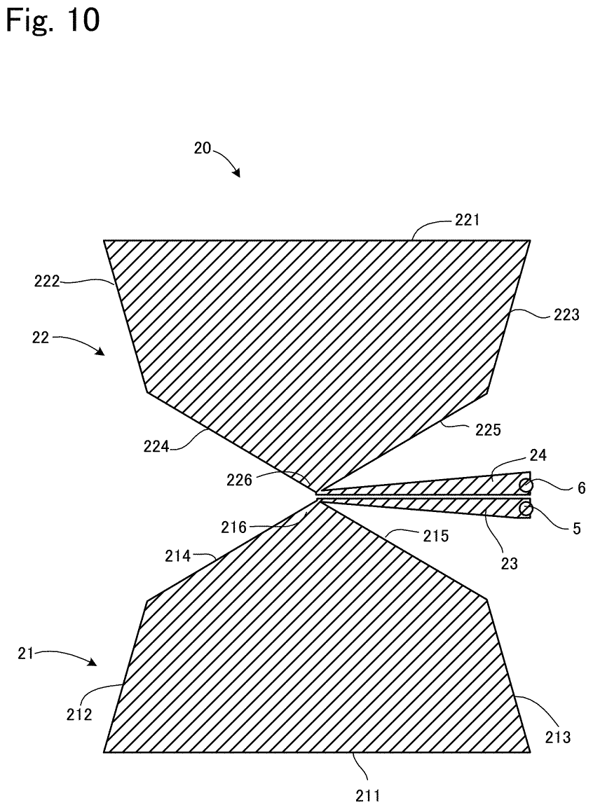

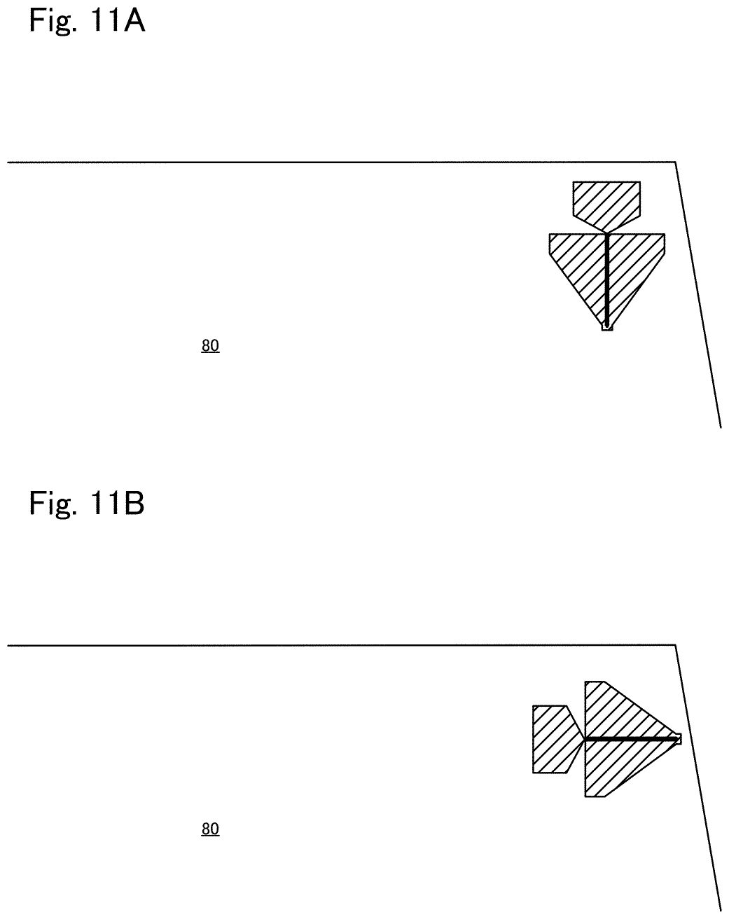

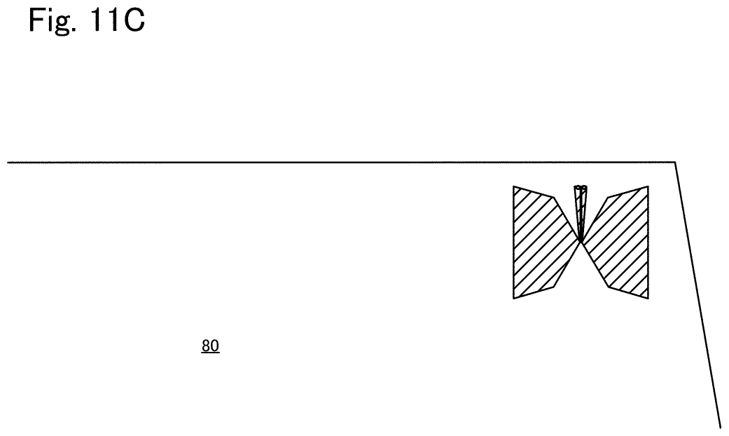

(5) There is no particular limitation to the orientation in which the glass antennas 10 and 20 are arranged on a window glass. The glass antennas 10 and 20 need only be arranged in an appropriate orientation, taking reception performance into consideration. Thus, in addition to the orientation shown in FIG. 1, the glass antenna may be turned upside down from FIG. 1 as shown in FIG. 11A, or may be tilted 90 degrees as shown in FIG. 11B, for example. Further, there is no particular limitation to the positions at which the glass antennas 10 and 20 are provided, and they can be provided at any position on the window glass 80. Also, in FIG. 11C, the second glass antenna 20 shown in FIG. 10 is tilted 90 degrees such that the track portions 23 and 24 are located upward. In this manner, there is no particular limitation to the rotation angle for the second glass antenna 20.

(6) Although the ground portion 5 is arranged at the vertex of the first portion 11 that is located farthest from the second portion 12 in the first glass antenna 10 of the embodiment, there is no particular limitation to the position of the ground portion 5. That is, the ground portion 5 need not be arranged at the vertex, and need only be arranged in the farthest portion such as on a side, or in the vicinity thereof, depending on the shape of the first portion 11.

### EXAMPLES

The following describes examples of the present invention. However, the present invention is not limited to the following examples.

Hereinafter, the reception performance of the glass antennas according to the examples 1 to 16 and a comparative example was examined. Three-dimensional electromagnetic field simulation software was used for examining reception performance. In this simulation, a glass plate was modeled, assuming a typical laminated glass in which an interlayer with a thickness of 0.76 mm was interposed between two pieces of glass with a thickness of 2.1 mm. Also, the shapes and sizes of the glass antennas are shown in Table 1 below, and the model was obtained assuming that the shortening coefficient a of the glass plate was 0.61 and radio waves had a frequency of 500 MHz to 6 GHz. As the simulation procedure, (1) a vehicle, a dielectric body, an antenna, and the like were modeled and the materials were set, (2) appropriate meshes for the vehicle, the dielectric body, the antenna and the like were set, and then simulation was executed.

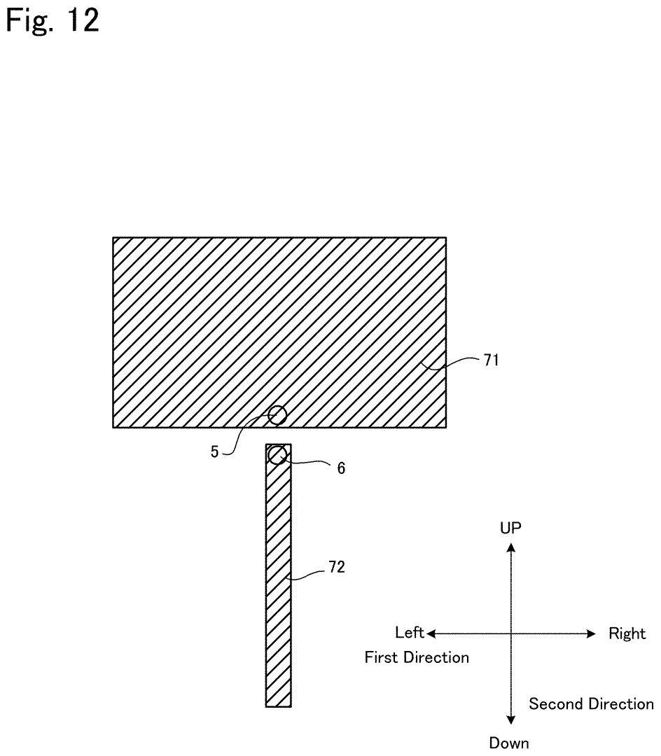

As shown in FIG. 12, the glass antenna according to the comparative example had a rectangular main body portion 71 and a linear track portion 72 that extended upward from the vicinity of an upper side of the upper side of the main body portion 71. A gap was formed between the main body portion 71 and the track portion 72. Also, the hot portion 6 was arranged at a lower end of the track portion 72, and the ground portion 5 was arranged in a portion facing the track portion 72 on the upper side of the main portion 71. Also, the examples 1 to 4 were formed as followed.

TABLE 1

| | Ex. 1 | | Ex. 2 | Ex. 3 | Ex. 4 | Comp. Ex. |
|---|---|---|---|---|---|---|
| Shape | similar | | similar | similar | similar | similar |
| | to that in | | to that in | to that in | to that in | to that in |
| | FIG. 2 | | FIG. 4 | FIG. 3 | FIG. 6 | FIG. 10 |
| Length in | 120 | mm | 78 mm | 85 mm | 67 mm | 30 mm |
| First | | | | | | |
| Direction | | | | | | |
| Length in | 155 | m | 141 mm | 140 mm | 127 mm | 33 mm |

Second
Direction

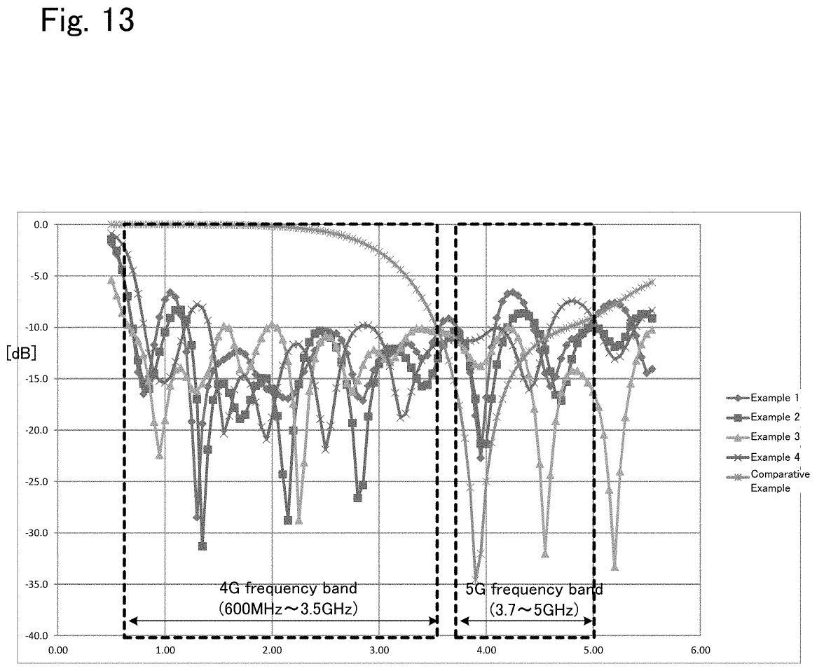

When simulation was performed using the examples 1 to 4 and the comparative example configured as described above, the results shown in FIG. 13 were obtained. FIG. 13 is a graph showing reception performance at a frequency of 500 MHz to 6 GHz. According to the inventors of the present invention, if a return loss of −7.4 dB or less is obtained, such antennas can withstand practical use. Based on FIG. 13, it was found that the comparative example had a favorable return loss in the 5G frequency band, but had a considerably poor return loss in the 4G frequency band. The examples 1 to 4 substantially had favorable return losses in both 4G and 5G frequency bands. Thus, it was found that, when two planar portions are provided as in the examples 1 to 4, a favorable return loss can be obtained in both 4G and 5G frequency bands. On the other hand, with the shape of the comparative example as shown in FIG. 12, the resonance frequency has a certain peak, and thus favorable resonance characteristics cannot be obtained over a wide band.

Comparing the examples 1 and 2, the length of the example 2 in the second direction was almost the same as the example 1, but the length of the example 2 in the first direction was about ⅔ of the length of the example 1 in the first direction. However, there was little difference in the reception performance due to this difference in size. Also, comparing the example 1 and 3, the examples 1 and 3 were different from each other mainly in the positions and the shapes of the track portions. As a result, the examples 1 and 3 had almost the same overall reception performances, but had high reception performance in different frequencies. The example 1 had high reception performance around 4 GHz in the 5G frequency band, whereas the example 3 had high reception performance around 4.5 GHz, for example. Also, comparing the examples 1 and 4, it was found that the lengths of the example 4 in the first direction and the second direction were shorter than that of the example 1, and thus the overall reception performance of the example 4 was lower than that of the example 1 in both the 4G and 5G frequency bands.

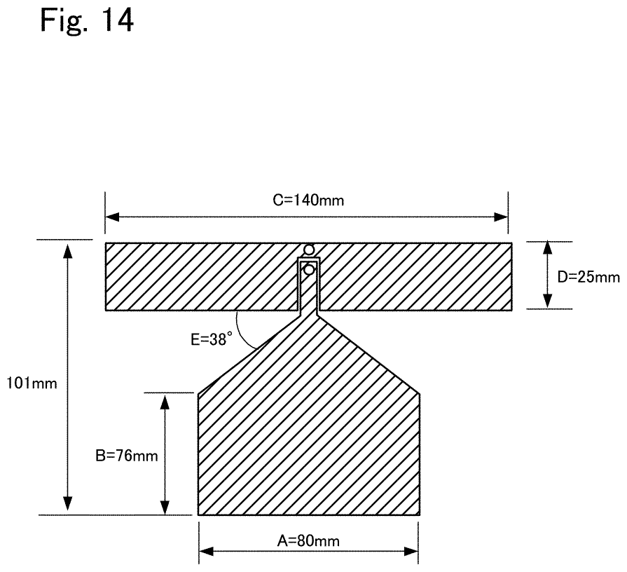

Next, the examples 5 to 15 were examined. The examples 5 to 15 were antennas having the shape shown in FIG. 14, and correspond to the above-described glass antenna shown in FIG. 7. The antenna having the dimension shown in FIG. 14 was the antenna according to the example 5. As shown in Table 2 below, the examples 6 to 15 were obtained by changing the dimensions A to D in FIG. 14 (in units of mm) and the angle E (in units of degrees).

TABLE 2

| | A | B | C | D | E |
|---|---|---|---|---|---|
| Ex. 5 | 80 | 76 | 140 | 25 | 38 |
| Ex. 6 | 70 | 76 | 140 | 25 | 38 |
| Ex. 7 | 90 | 76 | 140 | 25 | 38 |
| Ex. 8 | 80 | 66 | 140 | 25 | 38 |
| Ex. 9 | 80 | 86 | 140 | 25 | 38 |
| Ex. 10 | 80 | 76 | 120 | 25 | 38 |
| Ex. 11 | 80 | 76 | 160 | 25 | 38 |
| Ex. 12 | 80 | 76 | 140 | 15 | 38 |
| Ex. 13 | 80 | 76 | 140 | 30 | 38 |
| Ex. 14 | 80 | 76 | 140 | 25 | 30 |
| Ex. 15 | 80 | 76 | 140 | 25 | 45 |

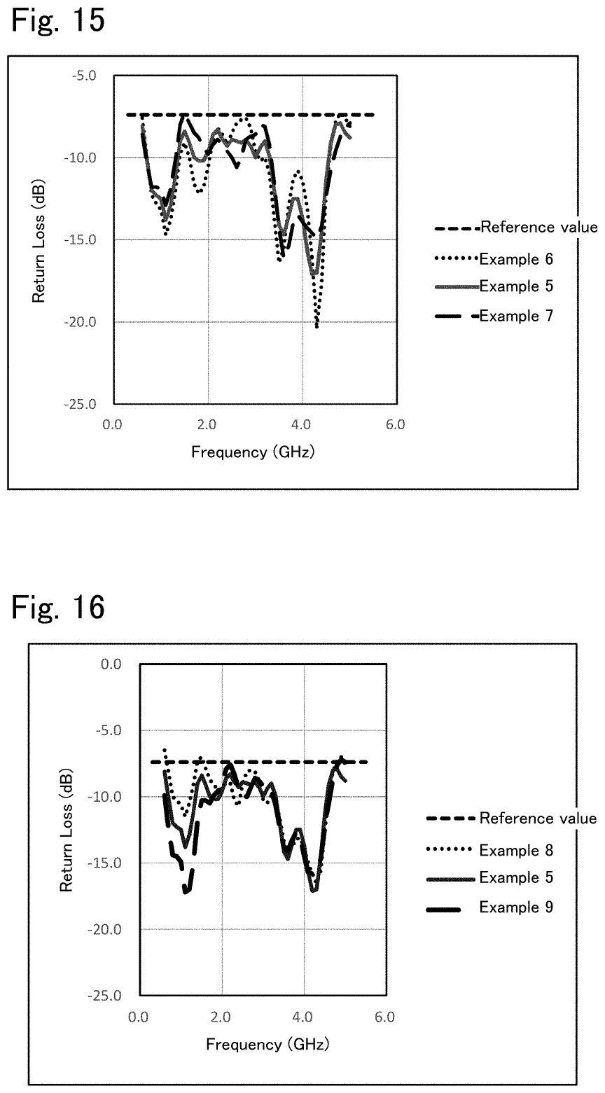

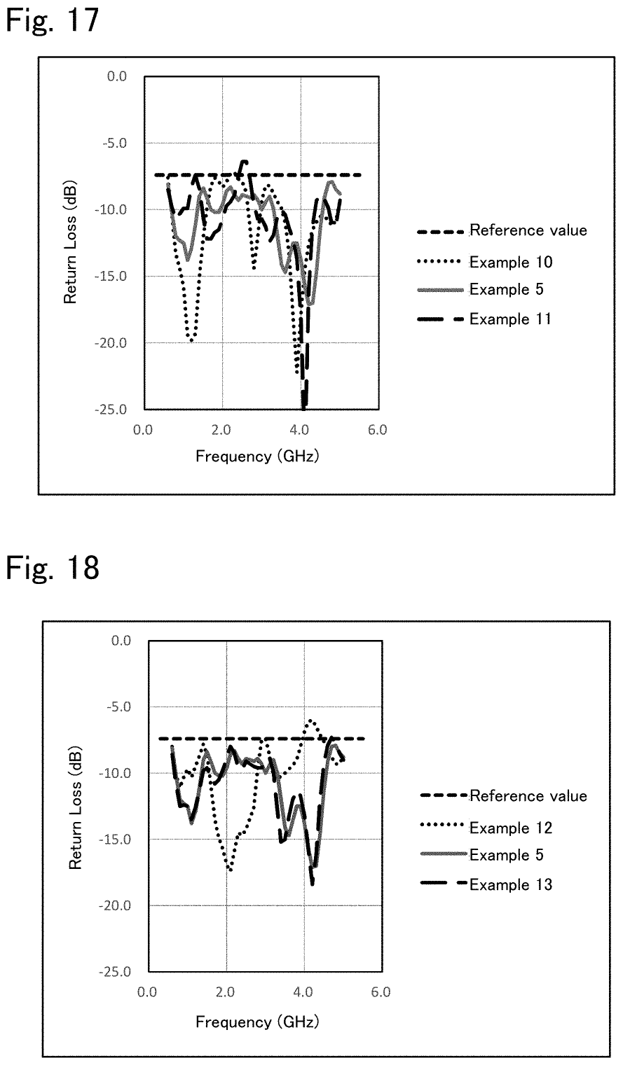

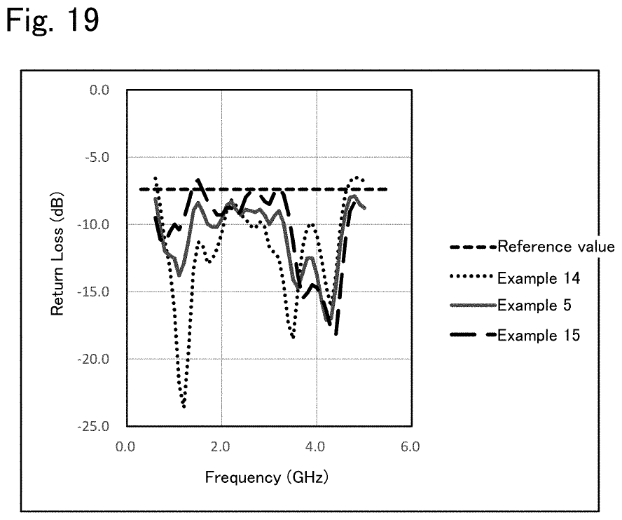

For the examples 5 to 15, the reception performance of the antennas was calculated in the same manner as in the examples 1 to 4. The results therefor are shown in FIGS. 15 to 19. It was found that the glass antennas having the shapes of the examples 5 to 15 substantially had a return loss of −7.4 dB (the reference value in FIGS. 15 to 19) or less, and could withstand practical use.

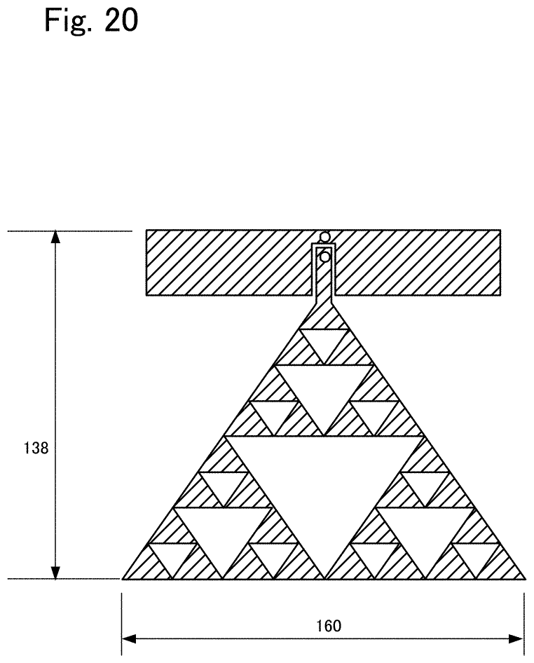

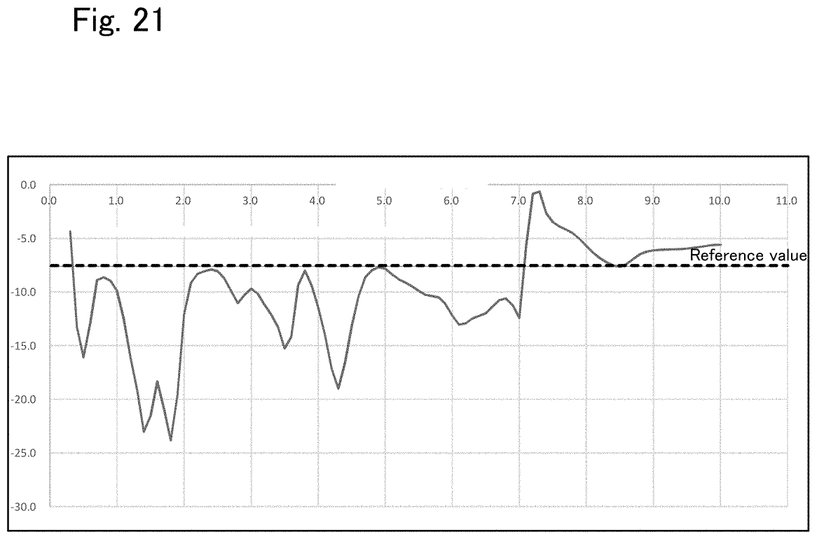

Then, the example 16 was examined. The example 16 was an antenna having the shape shown in FIG. 20, and corresponds to the above-described glass antenna (the numerical values in FIG. 20 are in units of mm) shown in FIG. 8. For the example 16, the reception performance of the antennas was calculated in the same manner as in the examples 1 to 4. The results therefor are shown in FIG. 21. In FIG. 21, the frequency (GHz) is shown on the horizontal axis, and the return loss (dB) is shown on the vertical axis. As shown in FIG. 21, it was found that the glass antennas having the shape of the example 16 had a return loss of −7.4 dB (the reference value in FIG. 21) described above or less in a range of 1.0 to 7.0 GHz, and could withstand practical use.

### LIST OF REFERENCE NUMERALS

11, 21 First portion
12, 22 Second portion
13 Track portion
23 First track portion
24 Second track portion
5 Ground portion
6 Hot portion
10, 20 Glass antenna
80 Window glass

1. A glass antenna to be provided on a window glass of a vehicle, the glass antenna comprising:
a hot portion;
a ground portion; and
an antenna main body connected to the hot portion and the ground portion,
wherein the glass antenna is configured to receive radio waves with a frequency band of 600 MHz to 5 GHz.

2. The glass antenna according to claim 1,
wherein the antenna main body includes:
a first portion that has a planar shape and is electrically connected to the ground portion, and
a second portion that is electrically connected to the hot portion and has a planar shape.

3. The glass antenna according to claim 2,
wherein an outer edge of at least one of the first portion and the second portion has at least one corner portion.

4. The glass antenna according to claim 2,
wherein at least one of the first portion and the second portion is formed by a polygon having linear sides.

5. The glass antenna according to claim 2,
wherein the ground portion is arranged in a vicinity of a portion of an outer peripheral edge of the first portion that is located farthest from the second portion.

6. The glass antenna according to claim 5,
wherein, when the wavelength of the radio waves is λ and a wavelength shortening coefficient in the window glass is α,
the distance from the hot portion to the second portion is α×λ/20 or more.

7. The glass antenna according to claim 5,
wherein the first portion is larger than the second portion.

8. The glass antenna according to claim 5,
wherein the first portion and the second portion are formed line-symmetrically with respect to a reference line passing through the ground portion and passing through the first portion and the second portion.

9. The glass antenna according to claim 2,
wherein one vertex of an outer peripheral edge of the first portion and one vertex of an outer peripheral edge of the second portion are arranged so as to face each other.

10. The glass antenna according to claim 9,
wherein the first portion and the second portion have a shape symmetrical with respect to a midpoint between the one vertex of the first portion and the one vertex of the second portion.

11. The glass antenna according to claim 9,
wherein the hot portion and the ground portion are arranged outside the first portion and the second portion.

12. The glass antenna according to claim 11, further comprising:
a first track portion extending so as to connect the ground portion and the first portion to each other; and
a second track portion extending in parallel to the first track portion so as to connect the hot portion and the second portion to each other.

13. The glass antenna according to claim 12,
wherein a gap between the first track portion and the second track portion is 1 mm or less.
